(19) United States
(12) Patent Application Publication
(10) Pub. No.: US 2026/0235265 A1
(43) Pub. Date: Aug. 13, 2026

(54) INTELLIGENT CONTROL INTERNET OF THINGS (IOT) SYSTEMS AND METHODS FOR PIPELINE BLOCK VALVES OF SMART GAS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei HE, Chengdu (CN)

(73) Assignee: CHENGDU QINCHUAN IOT TECHNOLOGY CO., LTD., Chengdu (CN)

(21) Appl. No.: 19/638,073

(22) Filed: Apr. 2, 2026

(30) Foreign Application Priority Data
Feb. 14, 2026 (CN) 202610216236.1

(51) Int. Cl. F17D 5/00; F17D 3/01; G16Y 10/35; G16Y 20/30; G16Y 40/50

(52) U.S. Cl. CPC F17D 5/005; F17D 3/01; G16Y 10/35; G16Y 20/30; G16Y 40/50

(57) ABSTRACT

Provided is an intelligent control IoT system and method for a pipeline block valve of smart gas, including: a management platform determining an estimated opening/closing duration of a block valve; adjusting a recipient set of a remote control command; generating an automatic opening command and sending the automatic opening command to an automatic control block valve; in response to gas data not satisfying a first preset condition, controlling a remote control block valve to close to block gas transmission; in response to the gas data satisfying a second preset condition, controlling the remote control block valve to open so as to resume gas transmission; determining an initial opening/closing condition of the automatic control block valve, so that the automatic control block valve sets an initial opening/closing parameter and automatically performs an opening and/or closing operation.

### CROSS-REFERENCE TO RELATED APPLICATIONS

This application claims priority to Chinese Application No. 202610216236.1, filed on February 14, 2026, the entire contents of which are incorporated herein by reference.

### TECHNICAL FIELD

The present disclosure relates to the field of gas valve technology, in particular to an intelligent control Internet of Things (IoT) system and method for a pipeline block valve of smart gas.

### BACKGROUND

In the technical field of gas valves, block valves are widely applied to pipeline systems to ensure effective shut-off of gas flow during emergencies or routine maintenance. Traditional block valves typically rely on remote control commands or automated systems to perform opening/closing operations spontaneously based on external conditions. However, the conventional technical solutions are unable to intelligently determine initial opening/closing way of the block valves, nor do they address the issue of how to intelligently determine whether the block valves of different gas pipelines need to change their opening/closing states. With the increasing complexity of urban gas pipeline networks, the operation mode of traditional block valves alone is no longer sufficient to meet the requirements of modern smart cities and safety management. Therefore, it is crucial to develop an intelligent control IoT system and method for a pipeline block valve of smart gas integrating the IoT technology to manage the operation of the block valve more intelligently and efficiently, thereby enhancing its reliability in the gas network.

### SUMMARY

One or more embodiments of the present disclosure provide an intelligent control IoT method for a pipeline block valve of smart gas, implemented by a smart gas company management platform of an intelligent control IoT system for a pipeline block valve of smart gas, including: determining an estimated opening/closing duration of a block valve based on block valve data of the block valve and historical gas data of a gas pipeline where the block valve is located; determining a control mode of the block valve based on the estimated opening/closing duration and gas pipeline data of the gas pipeline where the block valve is located, the control mode including automatic control and remote control; determining a remote control block valve group and an automatic control block valve group based on the control mode of the block valve; adjusting a recipient set of a remote control command based on the remote control block valve group, so that the remote control command is only sent to a remote control block valve; and generating an automatic opening command based on the automatic control block valve group and sending the automatic opening command to an automatic control block valve, so that the automatic control block valve performs automatic control on an opening or closing operation of the automatic control block valve; in response to gas data of the gas pipeline where the remote control block valve is located not satisfying a first preset condition, controlling the remote control block valve to close, to block gas transmission at a node of the remote control block valve; in response to the gas data of the gas pipeline where the remote control block valve is located satisfying a second preset condition, controlling the remote control block valve to open, to resume the gas transmission at the node of the remote control block valve, the first preset condition and the second preset condition being related to different gas data thresholds; determining an initial opening/closing condition of the automatic control block valve based on historical incident data of the gas pipeline where the automatic control block valve is located, and sending the initial opening/closing condition to the automatic control block valve, so that the automatic control block valve sets an initial opening/closing parameter based on the initial opening/closing condition and automatically performs an opening and/or closing operation based on the initial opening/closing parameter, the opening/closing parameter including a gas data threshold when the automatic control block valve needs to perform the opening/closing operation.

One or more embodiments of the present disclosure provide an intelligent control IoT system for a pipeline block valve of smart gas, including: a management platform and a device platform. The management platform is in communication connection to the device platform. The management platform is configured to execute the intelligent control IoT method for the pipeline block value of smart gas described above.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a schematic diagram illustrating an exemplary intelligent control IoT system for a pipeline block valve of smart gas according to some embodiments of the present disclosure;

FIG. 2 is a flowchart illustrating an exemplary intelligent control IoT method for a pipeline block valve of smart gas according to some embodiments of the present disclosure.

FIG. 3 is a schematic diagram illustrating an exemplary risk prediction model according to some embodiments of the present disclosure.

FIG. 4 is a flowchart illustrating an exemplary process of updating an opening/closing condition according to some embodiments of the present disclosure.

### DETAILED DESCRIPTION

In the following detailed description, numerous specific details are set forth by way of examples in order to provide a thorough understanding of the relevant disclosure. Obviously, the drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and are not intended to limit the scope of the present disclosure. Unless obviously obtained from the context or the context illustrates otherwise, the same numeral in the drawings refers to the same structure or operation.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood that the operations of the flowcharts may be implemented not in order. Conversely, the operations may be implemented in an inverted order or simultaneously. Moreover, one or more other operations may be added to the flowcharts. One or more operations may be removed from the flowcharts.

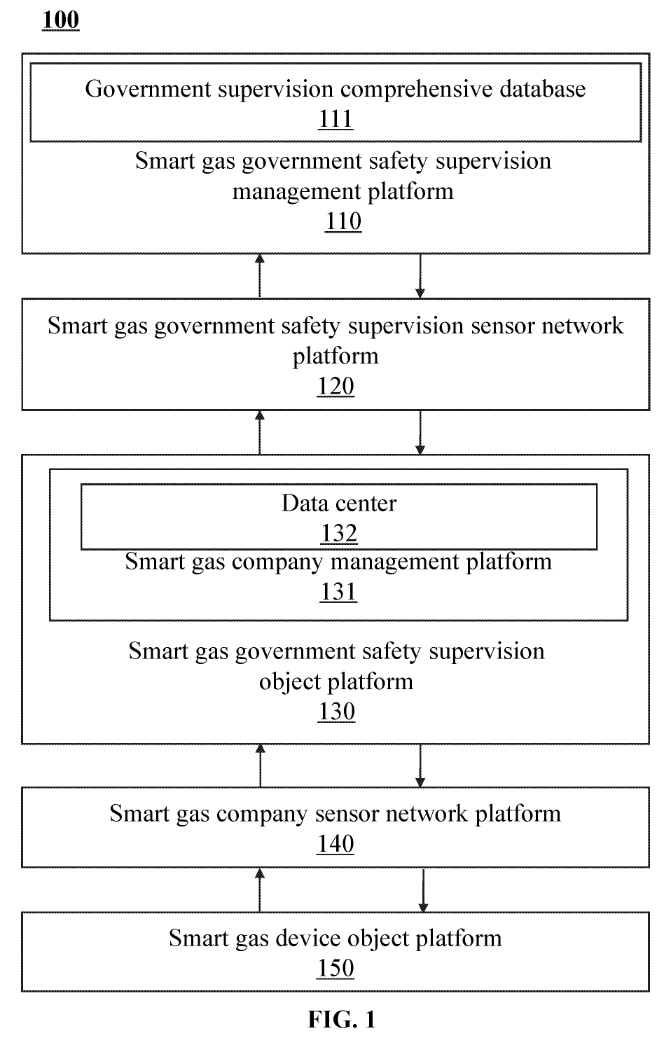

FIG. 1 is a schematic diagram illustrating an exemplary intelligent control IoT system for a pipeline block valve of smart gas according to some embodiments of the present disclosure.

In some embodiments, as shown in FIG. 1, an intelligent control IoT system for a pipeline block valve of smart gas 100 may include a smart gas government safety supervision management platform 110, a smart gas government safety supervision sensor network platform 120, a smart gas government safety supervision object platform 130, a smart gas company sensor network platform 140, and a smart gas device object platform 150.

The smart gas government safety supervision management platform 110 refers to a comprehensive management platform for government management information. In some embodiments, the smart gas government safety supervision management platform may include a government supervision comprehensive database 111 for query. The government supervision comprehensive database 111 refers to a database storing data related to the smart gas government safety supervision management platform 110. For example, the government supervision comprehensive database 111 may store information related to gas business, information related to gas safety, or the like. In some embodiments, the smart gas government safety supervision management platform 110 may be implemented based on a processor, a server, or the like.

In some embodiments, the smart gas government safety supervision management platform 110 may receive the information related to gas business and the information related to gas safety, such as block valve data of a gas pipeline, historical gas data of the gas pipeline where the block valve is located, etc., and store the information related to the gas business and the information related to the gas safety in the government supervision comprehensive database 111 to supervise and manage the gas business and the gas safety.

The smart gas government safety supervision sensor network platform 120 is a functional platform for managing government sensor communication. In some embodiments, the smart gas government safety supervision sensor network platform 120 may be implemented based on communication equipment, a server, or the like. In some embodiments, the smart gas government safety supervision sensor network platform 120 may implement functions of perception information sensor communication and control information sensor communication.

In some embodiments, the smart gas government safety supervision sensor network platform 120 may interact with the smart gas government safety supervision management platform 110 and the smart gas government safety supervision object platform 130.

The smart gas government safety supervision object platform 130 is a platform for the government to generate supervision information and execute control information. In some embodiments, the smart gas government safety supervision object platform 130 may include a smart gas company management platform 131. In some embodiments, the smart gas company management platform 131 may include a data center 132.

In some embodiments, the smart gas company management platform 131 may interact with the smart gas government safety supervision sensor network platform 120. For example, the smart gas company management platform 131 may obtain historical operation data (e.g., the historical gas data of the gas pipeline where the block valve is located) of the gas pipeline based on the smart gas government safety supervision sensor network platform 120. In some embodiments, the smart gas company management platform 131 may be configured on a server.

In some embodiments, the smart gas company management platform 131 may read data from the data center 132. For example, the smart gas company management platform 131 reads the gas pipeline data of the gas pipeline where the block valve is located.

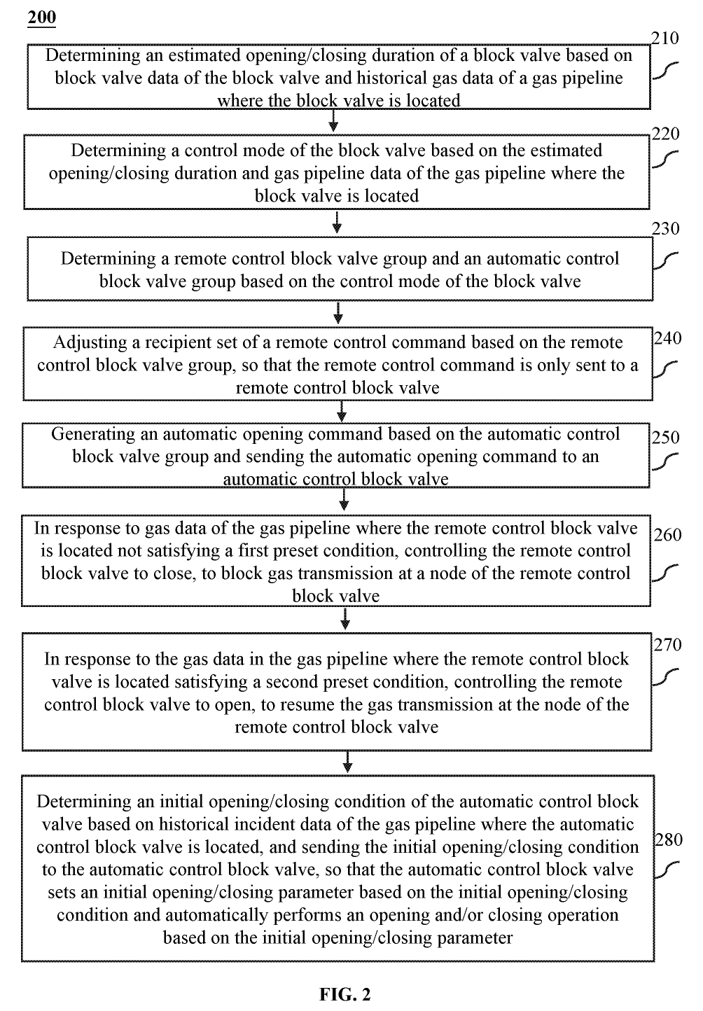

More descriptions regarding the smart gas company management platform 131 may be found in FIG. 2 and the relevant descriptions thereof.

The smart gas company sensor network platform 140 refers to a platform for comprehensive management of sensor information of a gas company. In some embodiments, the smart gas company sensor network platform 140 may be configured to implement the functions of perception information sensor communication and control information sensor communication. In some embodiments, the smart gas company sensor network platform 140 includes a communication base station, a router, and a wireless Wi-Fi device.

In some embodiments, the smart gas company sensor network platform 140 may be in communication connection to the smart gas government safety supervision object platform 130 and the smart gas device object platform 150.

The smart gas device object platform 150 refers to a platform for monitoring the gas pipeline and components of the gas pipeline.

In some embodiments, the smart gas equipment object platform 150 may be configured to include each gas pipeline and the components disposed on the gas pipeline (inside or on an outer wall), such as a valve, a sensor, or the like.

In some embodiments, the smart gas equipment object platform 150 may interact with the smart gas company management platform 131 through the smart gas company sensor network platform 140.

FIG. 2 is a flowchart illustrating an exemplary intelligent control IoT method for a pipeline block valve of smart gas according to some embodiments of the present disclosure. In some embodiments, a process 200 is performed by the smart gas company management platform 131 (hereinafter referred to as the management platform) of the intelligent control IoT system for the pipeline block valve of smart gas 100. As shown in FIG. 2, the process 200 includes the following operations:

In 210, determining an estimated opening/closing duration of a block valve based on block valve data of the block valve and historical gas data of a gas pipeline where the block valve is located

The block valve refers to a valve device for cutting off fluid flow in a pipeline, such as a valve provided in the gas pipeline for shutting off gas flow.

In some embodiments, the block valve data may include a usage distribution, a size, a type, and a driving force type of the block valve. The usage distribution of the block valve may include information such as a time, a duration, and a count of opening and/or closing operations of the block valve. The type of the block valve may include a ball valve, a butterfly valve, a gate valve, or the like. The driving force type of the block valve may include an electric type, a pneumatic type, or the like.

In some embodiments, the management platform may send a read command to the smart gas device object platform 150 when needed to read latest block valve data of the block valve.

In some embodiments, the historical gas data may include gas temperature data and gas pressure data of gas passing through the block valve within a historical time period.

In some embodiments, the management platform may send the read command to the smart gas device object platform 150 to read the historical gas data stored in a gas flow gauge, a gas meter, or the like.

The estimated opening/closing duration refers to an estimated duration required for opening/closing the block valve. For example, the estimated opening/closing duration is a duration from the start of opening (closing) the block valve to the completion of opening (closing) the block valve.

In some embodiments, the management platform may determine the estimated opening/closing duration of the block valve in a plurality of ways. For example, the management platform may obtain the estimated opening/closing duration by performing clustering analysis on historical opening/closing records of a historical block valve. The historical opening/closing records include historical block valve data of the historical block valve, the historical gas data, and a historical opening/closing duration.

The historical opening/closing duration refers to an actual opening/closing duration of the historical block valve within the historical time period. In some embodiments, the historical opening/closing duration may be obtained by measuring a time interval between a start time and an end time of displacement of an electric actuator/pneumatic actuator of the block valve using a displacement sensor mounted on the electric actuator/pneumatic actuator of the block valve.

The clustering analysis may include: constructing clustering vectors based on the historical block valve data and the historical gas data; performing clustering analysis on a plurality of historical opening/closing records based on vector distances between the clustering vectors to obtain a plurality of clusters; constructing a target vector based on current block valve data of the block valve and the historical gas data; designate a cluster containing a clustering vector with the highest similarity to the target vector as a target cluster; and using an average of historical opening/closing durations of a plurality of historical opening/closing records in the target cluster as the estimated opening/closing duration. The clustering analysis may be a K-means clustering algorithm, etc. A K value for a count of clusters in the K-means clustering algorithm may be preset by technical personnel.

In some embodiments, the management platform may be further configured to determine the estimated opening/closing duration of the block valve based on the block valve data of the block valve and the historical gas data of the gas pipeline where the block valve is located through a duration prediction model, the duration prediction model being a machine learning model.

The duration prediction model refers to a model configured to determine the estimated opening/closing duration of the block valve. In some embodiments, the duration prediction model may be the machine learning model. For example, the duration prediction model may be a neural network (NN) model, a deep neural network (DNN) model, or the like, or any combination thereof.

In some embodiments, an input of the duration prediction model includes the block valve data and the historical gas data of the gas pipeline where the block valve is located; an output of the duration prediction model includes the estimated opening/closing duration of the block valve.

In some embodiments, the duration prediction model may be trained using a large number of first training samples with first labels. The first training samples may include sample block valve data of a sample block valve and sample historical gas data of the gas pipeline where the sample block valve is located. In some embodiments, the first training samples may be determined based on historical data. In some embodiments, the first labels may be the historical opening/closing duration of the sample block valve.

In some embodiments, the management platform may input one or more first training samples into an initial prediction model to obtain the estimated opening/closing duration output by the initial prediction model; substitute the estimated opening/closing duration output by the initial prediction model and the corresponding first labels of the one or more first training samples into a predefined loss function equation to calculate a value of the loss function; and update model parameters of the initial prediction model in reverse based on the value of the loss function. Update manners of the model parameters may include gradient descent, or the like. In response to satisfying an iteration completion condition, the model training ends, and a trained duration prediction model is obtained. The iteration completion condition may include that the loss value is less than a loss threshold, or a count of iterations reaches a maximum iteration count.

In some embodiments of the present disclosure, predicting the estimated opening/closing duration of the block valve by the duration prediction model can quickly and accurately determine the estimated opening/closing duration of the block valve.

In 220, determining a control mode of the block valve based on the estimated opening/closing duration, and gas pipeline data of the gas pipeline where the block valve is located.

The gas pipeline data may include a height difference between two ends of a gas pipeline segment where the block valve is located, a count of bends within the gas pipeline segment, and a count of components within the gas pipeline segment.

In some embodiments, the management platform may read the gas pipeline data of the gas pipeline where the block valve is located from a data center of the management platform.

The control mode refers to a mode for opening and/or closing the block valve.

In some embodiments, the control mode includes automatic control and remote control.

The automatic control may be that the block valve automatically opens or closes when a certain condition is satisfied.

The remote control may be that the management platform sends a control command to the block valve to control the opening or closing of the block valve.

In some embodiments, the management platform may determine the control mode of the block valve in a plurality of ways. For example, the management platform may determine a pipeline complexity of the gas pipeline where the block valve is located based on the gas pipeline data of the gas pipeline; perform weighted summation of the pipeline complexity and the estimated opening/closing duration, weights being preset by technical personnel; in response to a weighted summation result being greater than or equal to a preset automatic control threshold, determine the control mode of the block valve as the automatic control; in response to the weighted summation result being less than the preset automatic control threshold, determine the control mode of the block valve as the remote control.

It is understood that although the management platform can perform more precise remote control of the block valve based on gas data across the entire gas pipeline network, for the block valve with the weighted summation result exceeding the preset automatic control threshold, the estimated opening/closing duration is relatively long and the pipeline complexity is high, the remote control in such cases is more prone to high latency, which may lead to a gas incident. Accordingly, the automatic control is adopted to enable the responsive operation of the block valve.

The pipeline complexity refers to a degree of complexity of the structure of the gas pipeline. In some embodiments, the pipeline complexity may be obtained based on weighted summation of the height difference between the two ends of the gas pipeline segment where the block valve is located, the count of bends within the gas pipeline segment, and the count of the components with the gas pipeline segment. The weight may be preset by the technical personnel.

In some embodiments, the preset automatic control threshold may be determined in a plurality of ways. For example, the preset automatic control threshold may be preset and determined by the technical personnel based on experience. As another example, the preset automatic control threshold may be negatively correlated with data transmission latency between the block valve and the management platform. The data transmission latency may be statistically obtained based on the historical data. When the data transmission latency is high, a relatively small preset automatic control threshold needs to be set to lower a threshold for the automatic control of the block valve, preventing untimely closing of the block valve due to the high data transmission latency.

In some embodiments, the management platform may determine the control mode of the block valve based on the estimated opening/closing duration, the gas pipeline data of the gas pipeline where the block valve is located, and an opening/closing state of the block valve.

The opening/closing state of the block valve refers to whether the block valve is currently opening or closing state.

In some embodiments, the management platform may determine the pipeline complexity of the gas pipeline based on the gas pipeline data of the gas pipeline where the block valve is located; determine weights of the estimated opening/closing duration and the pipeline complexity in the weighted summation based on the opening/closing state of the block valve; and determine the control mode of the block valve based on the weighted summation result.

In some embodiments, when the opening/closing state of the block valve is an open state, the weight of the pipeline complexity is greater than the weight of the estimated opening/closing duration; when the opening/closing state of the block valve is a closed state, the weight of the pipeline complexity is less than the weight of the estimated opening/closing duration.

It is understood that when the opening/closing state of the block valve is the opening state, it needs to determine whether the gas pipeline has returned to normal operation. In this case, it is even more important to consider the structure of the gas pipeline to avoid turbulence inside the pipeline. Accordingly, a greater weight is assigned to the pipeline complexity. When the opening/closing state of the block valve is the closed state, an incident has occurred in the gas pipeline, and the gas transmission needs to be shut off. In this case, the timeliness of the opening/closing operation of the block valve is more critical, so a greater weight is assigned to the estimated opening/closing duration.

In some embodiments of the present disclosure, the control mode of the block valve is determined based on the opening/closing state of the block valve, the gas pipeline data, and the estimated opening/closing duration, so that the control mode is set according to actual requirements of the block valve, thereby improving operation efficiency.

In 230, determining a remote control block valve group and an automatic control block valve group based on the control mode of the block valve.

The remote control block valve group refers to a set of block valves whose control mode is the remote control.

The automatic control block valve group refers to a set of block valves whose control mode is the automatic control.

In 240, adjusting a recipient set of a remote control command based on the remote control block valve group, so that the remote control command is only sent to a remote control block valve

The remote control command refers to a computer command for remotely controlling the block valve, such as a computer command issued by the management platform for remotely controlling the block valve to open and/or close.

The recipient set refers to a set of block valves that receive the remote control command.

The remote control block valve refers to a block valve whose opening and/or closing state is controlled by the remote control command.

In some embodiments, the management platform may adjust the recipient set of the remote control command in a plurality of ways. For example, the management platform may directly delete a current recipient set and utilize a latest remote control block valve group as the recipient set of the remote control command.

In some embodiments, in response to a change in the opening/closing state of the block valve, the management platform may determine an updated control mode of the block valve; adjust the recipient set of the remote control command based on the updated control mode; and/or generate an automatic opening command and send the automatic opening command to the block valve, so that the block valve performs automatic control on the opening/closing state of the block valve.

The change in the opening/closing state refers to the block valve changing from the opening state to the closed state or from the closed state to the opening state.

In some embodiments, when the opening/closing state of the block valve changes, the management platform may re-determine the control mode of the block valve based on the way described in the operation 230, thereby obtaining the updated control mode.

It is understood that a change in the opening/closing state of the block valve causes a change in weight allocation to the pipeline complexity and the estimated opening/closing duration in determining the control mode of the block valve; furthermore, due to differences in time periods and the historical gas data, the control mode determined based on the way described in the operation 230 may differ.

In some embodiments, the management platform may re-determine the remote control block valve group and the automatic control block valve group based on the updated control mode, thereby readjusting the recipient set of the remote control command.

In some embodiments of the present disclosure, the control mode of the block valve is re-determined when the opening/closing state of the block valve changes to adjust the recipient set of the remote control command, so that dynamic adjustment of the control mode can be realized, ensuring operation responsiveness of the block valve.

In 250, generating an automatic opening command based on the automatic control block valve group and sending the automatic opening command to an automatic control block valve, so that the automatic control block valve performs automatic control on the opening or closing operation of the automatic control block valve.

The automatic opening command refers to a computer command that enables the automatic control of the opening/closing state of the block valve. In some embodiments, when the block valve receives the automatic opening command, the block valve performs automatic control of the opening/closing state of the block valve.

In some embodiments, the management platform generates the corresponding automatic opening command based on the block valve data of the automatic control block valve in the automatic control block valve group, and sends the automatic opening command to the corresponding automatic control block valve.

In 260, in response to gas data of the gas pipeline where the remote control block valve is located not satisfying a first preset condition, controlling the remote control block valve to close, to block gas transmission at a node of the remote control block valve.

In some embodiments, the first preset condition may include gas temperature data being less than a first preset temperature threshold or gas pressure data being less than a first preset pressure threshold.

In some embodiments, the first preset temperature threshold and the first preset pressure threshold may be preset by the technical personnel.

In some embodiments, the first preset temperature threshold and the first preset pressure threshold may be adjusted based on the estimated opening/closing duration. For example, the management platform may proportionally lower the first preset temperature threshold and/or the first preset pressure threshold based on a magnitude of a difference between the estimated opening/closing duration and a standard opening/closing duration. The standard opening/closing duration may be determined based on an actual opening/closing duration of the block valve upon initial usage.

In some embodiments, when the estimated opening/closing duration differs significantly from the standard opening/closing duration, the block valve has undergone a certain degree of aging. In this case, lowering the first preset temperature threshold and/or the first preset pressure threshold reduces a determination condition for closing the block valve, thereby achieving more sensitive response to abnormalities in the gas pipeline and preventing the gas incident.

In 270, in response to the gas data of the gas pipeline where the remote control block valve is located satisfying a second preset condition, controlling the remote control block valve to open, to resume the gas transmission at the node of the remote control block valve.

In some embodiments, the first preset condition and the second preset condition are related to different gas data thresholds.

For example, the second preset condition may include the gas temperature data in the gas data being less than a second preset temperature threshold, and the gas pressure data being less than a second preset pressure threshold. The second preset temperature threshold and the second preset pressure threshold may be preset by the technical personnel. In some embodiments, the second preset temperature threshold is less than the first preset temperature threshold, and the second preset pressure threshold is less than the first preset pressure threshold.

In some embodiments, in response to the gas data of the gas pipeline where the remote control block valve is located satisfying the second preset condition, the management platform generates the remote control command to open the block valve and sends the remote control command to the remote control block valve, thereby controlling the remote control block valve to open and resume the gas transmission at the node of the remote control block valve.

In 280, determining an initial opening/closing condition of the automatic control block valve based on historical incident data of the gas pipeline where the automatic control block valve is located, and sending the initial opening/closing condition to the automatic control block valve, so that the automatic control block valve sets an initial opening/closing parameter based on the initial opening/closing condition and automatically performs an opening and/or closing operation based on the initial opening/closing parameter.

The historical incident data refers to gas data of the block valve when a gas incident occurred within the historical time period.

In some embodiments, the management platform may obtain the historical incident data from the data center.

The initial opening/closing condition refers to a condition for the automatic control block valve to determine whether to open or close. In some embodiments, the initial opening/closing condition may include an initial opening condition and an initial closing condition. The initial opening condition may include that the gas temperature data is less than an opening temperature threshold and the gas pressure data is less than an opening pressure threshold. The initial closing condition may include that the gas temperature data is higher than a closing temperature threshold or the gas pressure data is higher than a closing pressure threshold.

In some embodiments, the management platform may calculate an average value of the gas temperature data and an average value of the gas pressure data during stable operation of gas, and use the average values as the opening temperature threshold and the opening pressure threshold, respectively, to obtain the initial opening condition.

In some embodiments, the management platform may calculate an average value of the gas temperature data when the gas incident occurred in the historical incident data as the closing temperature threshold, and calculate an average value of the gas pressure data when the gas incident occurred as the closing pressure threshold, thereby obtaining the initial closing condition.

The initial opening/closing parameter refers to an opening/closing parameter for the automatic control block valve to determine whether to automatically open or close.

In some embodiments, the opening/closing parameter includes the gas data threshold when the automatic control block valve needs to perform the opening or closing operation. The gas data threshold may include the opening temperature threshold and the opening pressure threshold for the automatic control block valve to determine whether to automatically open, and the closing temperature threshold and the closing pressure threshold for the automatic control block valve to determine whether to automatically close.

In some embodiments, the management platform may determine the initial opening/closing parameter based on the initial opening/closing condition.

In some embodiments, when the gas temperature data of the gas data of the gas pipeline where the automatic control block valve is located is below the opening temperature threshold, and the gas pressure data is below the opening pressure threshold, the automatic control block valve automatically opens.

In some embodiments, when the gas temperature data of the gas data of the gas pipeline where the automatic control block valve is located is higher than the closing temperature threshold, or the gas pressure data is higher than the closing pressure threshold, the automatic control block valve automatically closes.

In some embodiments of the present disclosure, by determining the estimated opening/closing duration of the block valve based on the block valve data and the historical gas data, the block valves are classified into the remote control block valve group and the automatic control block valve group, so that different control modes are adopted for different block valves, facilitating more responsive operation of the block valve; by controlling the opening/closing of the remote control block valve based on the first preset condition and the second preset condition, the block valve operation is accurately actuated when needed to avoid gas safety hazards caused by emergencies or gas maintenance; by enabling automatic control of the opening/closing of the automatic control block valve based on the initial opening/closing condition, the system responds more promptly to emergencies in the gas pipeline and shuts off the gas flow promptly to ensure safe operation of the gas pipeline.

It should be noted that the description of the process 200 above is merely for illustration and explanation, and does not limit the scope of application of the present disclosure. For those skilled in the art, various modifications and changes to the process 200 may be made under the guidance of the present disclosure. However, these modifications and changes are still within the scope of the present disclosure.

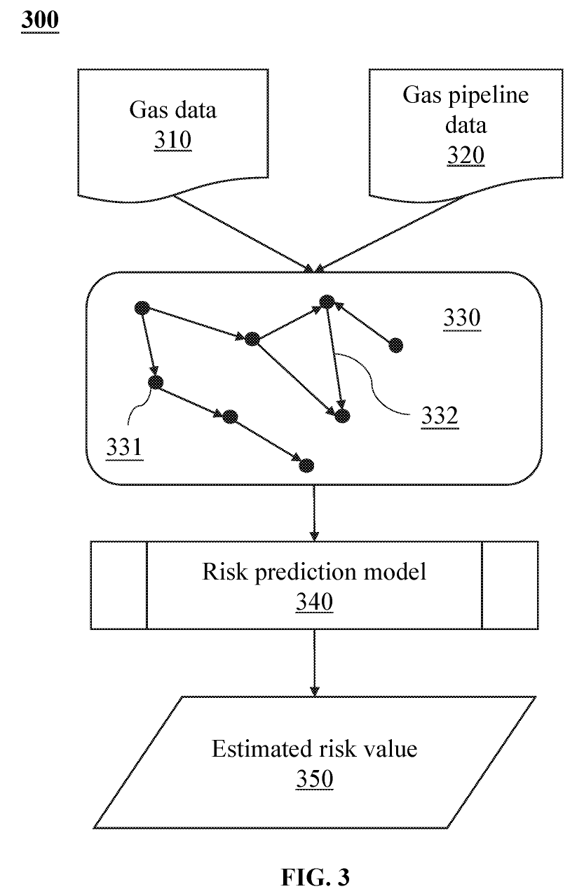

FIG. 3 is a schematic diagram illustrating an exemplary risk prediction model according to some embodiments of the present disclosure.

In some embodiments, the first preset condition further includes that an estimated risk value of the gas pipeline where the remote control block valve is located in a preset future time period is not greater than a preset risk threshold. The management platform determines the predicted risk value, including: constructing a risk map 330 based on gas data 310 and gas pipeline data 320 of the gas pipeline where the remote control block valve is located; and determining an estimated risk value 350 of the gas pipeline where the remote control block valve is located in the preset future time period through a risk prediction model 340 based on the risk map 330, the risk prediction model being machine learning model.

The preset future period may be a time period within one week, one month, etc., after a current moment, and may be preset.

The predicted risk value may represent a likelihood of the gas incident occurring in the gas pipeline in the future.

The preset risk threshold refers to a maximum acceptable predicted risk value, which may be preset by management personnel based on prior experience.

In some embodiments, the preset risk threshold is related to environmental operation condition data in a preset historical time period.

The preset historical time period may be a past week, a past month, etc., and may be preset by the technical personnel.

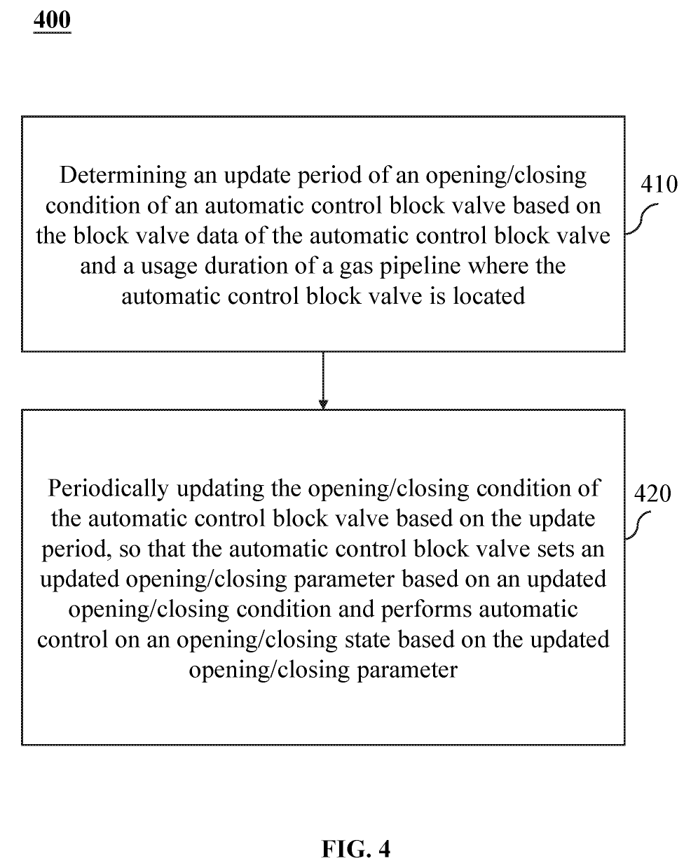

In some embodiments, the management platform may calculate a temperature range from environmental temperature data and a humidity range from environmental humidity data of the environmental operation condition data of the preset historical time period, and determine a weighted sum of the temperature range and the humidity range; and determine the preset risk threshold based on the weighted sum. The greater the weighted sum, the smaller the preset risk threshold. A weight for the weighted sum is preset by the technical personnel. More descriptions regarding the environmental operation condition data may be found in FIG. 4 and the relevant descriptions thereof.

In some embodiments of the present disclosure, the preset risk threshold is determined based on the environmental operation condition data over the historical time period. When the environmental operation condition data exhibits a significant variation, the preset risk threshold is lowered to promptly close the remote control block valve, thereby ensuring the safety of gas transmission.

The risk map refers to a graph structure constructed based on data related to the gas incident. In some embodiments, the risk map 330 is a directed graph structure. A node 331 of the risk map may correspond to the block valve in the gas pipeline network, and node features may include gas data at the block valve, block valve data, and a type of the block valve. The type of the block valve includes a remote control block valve or an automatic control block valve; an edge 332 of the risk map 230 may correspond to a gas pipeline directly connecting two block valves, with a direction of gas flow in the gas pipeline as a direction of the edge 332. Edge features may include a distance between the two block valves and gas pipeline data. More descriptions regarding the block valve data, the gas data, and the gas pipeline data may be found in FIG. 2 and the relevant descriptions thereof.

In some embodiments, the management platform may obtain the gas data in the gas pipeline network, the block valve data, the gas pipeline data, and distances between the block valves from a data center to construct the risk map 330. The management platform may obtain the latest gas data, block valve data, or gas pipeline data to update the risk map 330.

The risk prediction model refers to a model for determining the estimated risk value. In some embodiments, the risk prediction model is the machine learning model, such as a graph neural network (GNN) model, or the like.

In some embodiments, an input of the risk prediction model 340 includes the risk map 330, and an output of the risk prediction model 340 includes the estimated risk value 350 of the gas pipeline corresponding to the edge connected to the node associated with each remote control block valve in the preset future time period.

In some embodiments, the risk prediction model may be trained based on a large number of second training samples with second labels. The second training samples include a sample risk map, and the second labels include a historical risk value of a gas pipeline corresponding to an edge connected to the remote control block valve in the sample risk map.

The second training samples may be constructed based on historical gas data, historical block valve data, historical gas pipeline data, and distances between historical block valves in a first historical time period. The second labels may be determined based on gas incident data of a sample gas pipeline of a sample remote control block valve node in the second training samples during a second historical time period. For example, a count of historical incidents that occurred may be directly used as the second label for the edge corresponding to the sample gas pipeline. The first historical time period is earlier than the second historical time period.

In some embodiments, a training data set for training the risk prediction model includes a plurality of training subsets. One of the training subsets corresponds to at least one gas pipeline class, and a count of training subsets corresponding to each gas pipeline class is greater than a subset quantity threshold associated with the gas pipeline class; the subset quantity threshold corresponding to each gas pipeline class is determined based on a count of opening/closing operations of sample block valves corresponding to sample gas pipelines included in the training subsets of the gas pipeline class.

The training data set refers to a set composed of second training samples. The training subset may include one or more second training samples.

The gas pipeline class refers to a class obtained by classifying gas pipelines. For example, the gas pipeline class is obtained by classifying the gas pipelines based on the gas data and the gas pipeline data.

In some embodiments, the management platform may construct a pipeline feature vector corresponding to the gas pipeline based on the gas data and the gas pipeline data; perform clustering on the gas pipeline based on the pipeline feature vector to obtain a plurality of pipeline clusters; and designate each of the pipeline clusters as one gas pipeline class. The clustering ways include, but are not limited to, K-means clustering, DBSCAN clustering, and density peak clustering. In some embodiments, the management platform may determine the subset quantity threshold corresponding to the gas pipeline class based on a statistical value of the count of opening/closing operations of the sample block valves on the sample gas pipelines associated with the gas pipeline class. For example, the statistical value of the count of opening/closing operations may include a standard deviation of the count of opening/closing operations of a plurality of sample block valves on the sample gas pipelines corresponding to the gas pipeline class; the greater the standard deviation of the count of opening/closing operations, the larger the subset quantity threshold corresponding to the gas pipeline class.

It is understood that for the sample gas pipeline corresponding to the gas pipeline class, the greater the standard deviation of the count of opening/closing operations of the block valve, the greater the differences in the gas data at each block valve in the corresponding gas pipeline network, which increases, to some extent, the complexity of the risk prediction model when predicting the estimated risk value. Therefore, to ensure the accuracy and generalization capability of the trained risk prediction model, the sample gas pipelines of each gas pipeline class must have a sufficient count of samples in the second training samples.

In some embodiments of the present disclosure, by imposing a lower limit on the count of samples for each gas pipeline class in the second training samples, the risk prediction model can avoid overfitting or underfitting due to uneven gas pipeline classes, thereby improving the accuracy and generalization ability of the model.

In some embodiments, the management platform may train an initial risk prediction model based on the second training samples and the corresponding second labels to obtain a trained risk prediction model. The specific training process is similar to the training process of the duration prediction model, which may be found in the training process of the duration prediction model in the operation 210 of FIG. 2 and relevant descriptions thereof.

In some embodiments of the present disclosure, the risk map is constructed based on the gas pipeline data, the gas data, and the block valve data of the gas pipeline network, and the risk prediction model processes the risk map to generate the estimated risk value, which are used as the first preset condition to control the opening/closing of the remote control block valve, so that the gas incident risk in the gas pipeline network can be more accurately identified and the shut-off operation can be performed in time, thereby enhancing the operation safety and emergency response efficiency of the gas pipeline network.

FIG. 4 is a flowchart illustrating an exemplary process of updating an opening/closing condition according to some embodiments of the present disclosure. In some embodiments, a process 400 is performed by the smart gas company management platform 131 (hereinafter referred to as the management platform) of the intelligent control IoT system for the pipeline block valve of smart gas 100. As shown in FIG. 4, the process 400 includes the following operations:

In some embodiments, the management platform may update an initial opening/closing parameter by performing the following operation 410 to operation 420 to obtain an updated opening/closing parameter.

In 410, determining an update period of an opening/closing condition of an automatic control block valve based on block valve data of the automatic control block valve and a usage duration of a gas pipeline where the automatic control block valve is located.

The usage duration of the gas pipeline refers to a duration from mounting and commissioning of the gas pipeline to a current moment. In some embodiments, the usage duration of the gas pipeline may be expressed in a time unit, such as days, etc.

The update period refers to a duration between two consecutive updates of the opening/closing condition, such as one week, etc.

In some embodiments, the management platform may determine the update period of the automatic control block valve based on the block valve data of the automatic control block valve and the usage duration of the gas pipeline where the automatic control block valve is located by querying a preset period table.

The preset period table records update periods corresponding to different block valve data and usage durations of the gas pipeline where the block valves are located.

In some embodiments, for a plurality of historical automatic control block valves located in different gas pipeline networks, the management platform may perform clustering based on historical block valve data of each historical automatic control block valve and a historical usage duration of the gas pipeline where each historical automatic control block valve is located to obtain a plurality of automatic control clusters; for each of the automatic control clusters, among the plurality of historical update periods corresponding to the plurality of historical automatic control block valves, the management platform selects a historical update period corresponding to a highest count of adjustments to the opening/closing parameter during the update as the update period corresponding to the automatic control cluster, and records the update period in the preset period table. The clustering ways that may be used here may be found in relevant descriptions of determining the gas pipeline class in FIG. 3.

In some embodiments, in response to satisfying a preset period condition, the management platform may adjust the update period. The preset period condition may include that the opening/closing parameter of the automatic control block valve is updated in N consecutive update periods, or the opening/closing parameter of the automatic control block valve is not updated in M consecutive update periods.

In some embodiments, values of N and M may be set by the technical personnel based on experience.

In some embodiments, the value of M may be related to a distribution density of the automatic control block valves in the gas pipeline network. The larger the distribution density of the automatic control block valves, the greater the value of M. The distribution density of the automatic control block valves may include an average value of a count of the automatic control block valves in a plurality of unit regions in the gas pipeline network. The unit region may be a residential community, etc.

It can be understood that the larger the distribution density of the automatic control block valves, the more complex the connectivity within the gas pipeline network or the distribution of gas data at each point. In this case, the value of M is increased, and the update period is adjusted after the gas pipeline network is stabilized, thereby enhancing the operation stability of the gas pipeline network.

In some embodiments, if the opening/closing parameter of the automatic control block valve is updated in the N consecutive update periods, the management platform shortens the update period by a preset adjustment amount; if the opening/closing parameter of the automatic control block valve remain unchanged in the M consecutive update periods, the management platform extends the update period by the preset adjustment amount.

In some embodiments, the preset adjustment amount may be set by the technical personnel based on experience, such as one day, etc.

In some embodiments of the present disclosure, by adjusting the update period according to whether the opening/closing parameter of the block valve is updated in a plurality of update periods, the rationality of the update period is ensured, thereby guaranteeing the timeliness and sensitivity of the opening/closing parameter of the automatic control block valve.

In 420, periodically updating the opening/closing condition of the automatic control block valve based on the update period, so that the automatic control block valve sets an updated opening/closing parameter based on an updated opening/closing condition and performs automatic control on an opening/closing state based on the updated opening/closing parameter.

In some embodiments, the management platform may update the opening/closing condition of the automatic control block valve every update period.

In some embodiments, the management platform transmits the updated opening/closing parameter to the corresponding automatic control block valve in the smart gas device object platform 150 through the smart gas company sensor network platform 140 every update period to periodically update the opening/closing condition of the automatic control block valve.

The updated opening/closing parameter refers to an opening/closing parameter obtained by updating the initial opening/closing parameter.

In some embodiments, the management platform may determine the updated opening/closing parameter in a plurality of ways. For example, the management platform may re-determine the opening/closing parameter of the automatic control block valve based on the updated opening/closing condition according to a manner of determining the initial opening/closing parameter to obtain the updated opening/closing parameter. More descriptions regarding determining the initial opening/closing parameters may be found in FIG. 2 and the relevant descriptions thereof.

In some embodiments, the management platform may acquire environmental operation condition data in a preset historical time period at the beginning of each update period; determine the opening/closing condition of the automatic control block valve in a next period based on the block valve data of the automatic control block valve, the environmental operation condition data, and future gas data in the next period; generate a parameter update command based on the opening/closing condition, to control the automatic control block valve to update the opening/closing parameter.

The environmental operation condition data refers to data related to an operation environment of the block valve. For example, the environmental operation condition data includes a temperature data sequence and a humidity data sequence of an external environment of the pipeline, and a vibration intensity sequence of the pipeline. The temperature data sequence, the humidity data sequence, and the vibration intensity sequence may include temperature data, humidity data, and vibration intensity at a plurality of time points, respectively.

In some embodiments, the management platform may obtain the environmental operation condition data in the preset historical time period from the data center. The environmental operation condition data in the data center is collected and uploaded in real time by an environmental monitoring device (e.g., a temperature sensor, a humidity sensor, a vibration sensor, or the like) of the smart gas device object platform 150 in the preset historical time period. More descriptions regarding the preset historical time period may be found in FIG. 3 and the relevant descriptions thereof.

The future gas data refers to gas data of a future time period, such as the gas data in a next update period.

In some embodiments, the management platform may determine the future gas data based on a gas transmission plan of the gas company for the next update period.

In some embodiments, the management platform may construct a feature vector based on the block valve data of the automatic control block valve, the environmental operation condition data, and the future gas data for the next update period; perform retrieval in a gas vector database using the feature vector to obtain a reference feature vector with the highest similarity; and use a reference opening/closing condition corresponding to the reference feature vector with the highest similarity as the opening/closing condition for the next update period.

The gas vector database includes reference feature vectors constructed from the block valve data of a plurality of historical automatic control block valves and the environmental operation condition data of a plurality of historical gas pipelines during a third historical time period, and corresponding gas data from a fourth historical time period; and the reference opening/closing condition corresponding to each of the reference feature vectors. The third historical time period is earlier than the fourth historical time period. The reference opening/closing condition refers to, among the plurality of historical opening/closing conditions corresponding to the reference feature vectors in the historical data, a reference opening/closing condition where the triggering of the historical opening/closing condition causes the opening the closing state of the historical block valve to change, and the time required for the gas pressure on two sides of the block valve to reach a stable state is the minimum.

In some embodiments, the management platform may determine the opening/closing condition of the automatic control block valve in the next period based on the block valve data of the automatic control block valve, the environmental operation condition data, and the future gas data in the next period through a threshold prediction model.

The threshold prediction model refers to a model configured to determine the opening/closing condition in the next period. In some embodiments, the threshold prediction model is a machine learning model, such as a convolutional neural network (CNN) model, a deep neural network (DNN) model, or the like, or any combination thereof. In some embodiments, the threshold prediction model may include a feature extraction layer and a threshold determination layer.

An input of the feature extraction layer may include the environmental operation condition data. An output of the feature extraction layer may include an environmental operation condition feature.

The environmental operation condition feature refers to data extracted from the environmental operation condition data. In some embodiments, the environmental operation condition feature may include a data sequence composed of the temperature data, the humidity data, and the vibration intensity of the pipeline at one or more time points.

In some embodiments, the feature extraction layer may be obtained by training based on a large number of third training samples with third labels. The third training samples may include sample environmental operation condition data of sample gas pipelines where a plurality of sample automatic control block valves are located. The third labels may include the environmental operation condition feature of the sample gas pipeline where the automatic control block valve corresponding to the third training sample is located. In some embodiments, the third training samples may be constructed based on historical environmental operation condition data of the gas pipeline where the historical automatic control block valves are located; determining the third labels may include: forming a plurality of difference candidate environmental operation condition features from the temperature data, the humidity data, and the vibration intensity at the plurality of time points selected from the third training samples; inputting each of the candidate environmental operation condition features together with the block valve data of the sample automatic control block valve and a sample future environmental feature into the threshold determination layer to obtain candidate opening/closing conditions; and designating a candidate environmental operation condition feature corresponding to a candidate opening/closing condition that has the smallest deviation from the initial opening/closing condition as the third label.

The training process of the feature extraction layer is similar to the training process of the duration prediction model. The training process of the duration prediction model may be found in the relevant descriptions of the operation 210 in FIG. 2.

In some embodiments, an input of the threshold determination layer may include the environmental operation condition feature, the future gas data, and the block valve data of the automatic control block valve. An output of the threshold determination layer may include the opening/closing parameter of the automatic control block valve in the next period.

In some embodiments, the threshold determination layer may be obtained by training based on a large number of fourth training samples with fourth labels. The fourth training samples include the sample environmental operation condition feature, the sample future gas data, and the block valve data of the sample automatic control block valve. The fourth labels may include the opening/closing condition of the sample automatic control block valve in the next period. In some embodiments, the fourth training samples may be constructed based on the historical environmental operation condition features of the historical gas pipelines where the plurality of historical automatic control block valves are located in a fifth historical time period, the historical gas data and the historical block valve data in a sixth historical time period. The fourth labels may be constructed based on a historical opening/closing condition, among the plurality of historical automatic control valves corresponding to the plurality of historical automatic control block valves in the sixth historical time period, where the opening/closing state of the block valve changes, the time required for the gas pressure on two sides of the block valve to reach a stable state is the minimum. The fifth historical time period may be earlier than the sixth historical time period.

The training process of the threshold determination layer is similar to the training process of the duration prediction model. The training process of the duration prediction model may be found in the relevant descriptions of the operation 210 in FIG. 2.

In some embodiments of the present disclosure, by processing the environmental operation condition data, the block valve data, and the future gas data through the threshold prediction model to obtain the opening/closing condition of the automatic control block valve in the next period, more accurate and reasonable opening/closing condition in the next period can be achieved.

The parameter update command refers to a computer command for updating the opening/closing parameter of the automatic control block valve. For example, the parameter update command is a command for replacing and updating the initial opening/closing condition of the automatic control block valve.

In some embodiments, the management platform may use the opening/closing condition in the next period as the updated opening/closing condition and generate a corresponding parameter update command.

In some embodiments, the management platform may transmit the parameter update command to the corresponding automatic control block valve in the smart gas device object platform through the smart gas company sensor network platform 140, to update the opening/closing parameter of the automatic control block valve.

In some embodiments of the present disclosure, by determining the opening/closing condition of the next update period based on the environmental operation condition data and the block valve data of the preset historical time period, and the future gas data of the next update period, the updated opening/closing parameter is more in line with the gas transmission condition in the future time period, thereby enhancing relevance and effectiveness of the opening/closing parameter of the automatic control block valve.

In some embodiments of the present disclosure, by determining the update period of the opening/closing condition based on the block valve data and the usage duration of the block valve, the opening/closing parameter of the block valve is periodically updated, thereby ensuring the timeliness and accuracy of the block valve.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the count of ingredients and attributes are used. It should be understood that such numbers used for the description of the embodiments use the modifier "about", "approximately", or "substantially" in some examples. Unless otherwise stated, "about", "approximately", or "substantially" indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teachings of the present disclosure. Accordingly, the embodiments of the present disclosure are not limited to the embodiments introduced and described in the present disclosure explicitly.

What is claimed is:

1. An intelligent control IoT system for a pipeline block valve of smart gas, comprising a smart gas company management platform; wherein the smart gas company management platform is configured to:
determine an estimated opening/closing duration of a block valve based on block valve data of the block valve and historical gas data of a gas pipeline where the block valve is located;
determine a control mode of the block valve based on the estimated opening/closing duration and gas pipeline data of the gas pipeline where the block valve is located, wherein the control mode includes automatic control and remote control;
determine a remote control block valve group and an automatic control block valve group based on the control mode of the block valve;
adjust a recipient set of a remote control command based on the remote control block valve group, so that the remote control command is only sent to a remote control block valve; and
generate an automatic opening command based on the automatic control block valve group and send the automatic opening command to an automatic control block valve, so that the automatic control block valve performs automatic control on an opening or closing operation of the automatic control block valve.

2. The intelligent control IoT system according to claim 1, wherein the smart gas company management platform is further configured to:
in response to gas data of a gas pipeline where the remote control block valve is located not satisfying a first preset condition, control the remote control block valve to close, to block gas transmission at a node of the remote control block valve;
in response to the gas data of the gas pipeline where the remote control block valve is located satisfying a second preset condition, control the remote control block valve to open, to resume the gas transmission at the node of the remote control block valve; wherein the first preset condition and the second preset condition are related to different gas data thresholds; and
determine an initial opening/closing condition of the automatic control block valve based on historical incident data of a gas pipeline where the automatic control block valve is located, and send the initial opening/closing condition to the automatic control block valve, so that the automatic control block valve sets an initial opening/closing parameter based on the initial opening/closing condition and automatically performs an opening or closing operation based on the initial opening/closing parameter; wherein the opening/closing parameter includes a gas data threshold when the automatic control block valve needs to perform the opening/closing operation.

3. The intelligent control IoT system according to claim 1, wherein the smart gas company management platform is further configured to:
determine the estimated opening/closing duration of the block valve based on the block valve data of the block valve and the historical gas data of the gas pipeline where the block valve is located through a duration prediction model; wherein the duration prediction model is a machine learning model.

4. The intelligent control IoT system according to claim 1, wherein the smart gas company management platform is further configured to:
determine the control mode of the block valve based on the estimated opening/closing duration, the gas pipeline data of the gas pipeline where the block valve is located, and an opening/closing state of the block valve.

5. The intelligent control IoT system according to claim 4, wherein the smart gas company management platform is further configured to:
in response to a change in the opening/closing state of the block valve, determine an updated control mode of the block valve;
adjust the recipient set of the remote control command based on the updated control mode; and/or
generate an automatic opening command and send the automatic opening command to the block valve, so that the block valve performs automatic control on the opening/closing state.

6. The intelligent control IoT system according to claim 2, wherein the first preset condition includes that an estimated risk value of the gas pipeline where the remote control block valve is located in a preset future time period is not greater than a preset risk threshold;
the smart gas company management platform is further configured to:
construct a risk map based on the gas data and gas pipeline data of the gas pipeline where the remote control block valve is located; and
determine the estimated risk value of the gas pipeline where the remote control block valve is located in the preset future time period through a risk prediction model based on the risk map, wherein the risk prediction model is a machine learning model.

7. The intelligent control IoT system according to claim 6, wherein a training data set for training the risk prediction model includes a plurality of training subsets, one of the plurality of training subsets corresponds to at least one gas pipeline class, a quantity of training subsets corresponding to each gas pipeline class is greater than a subset quantity threshold corresponding to the gas pipeline class; and the subset quantity threshold corresponding to each gas pipeline class is determined based on a count of opening/closing operations of sample block valves corresponding to sample gas pipelines contained in the training subsets corresponding to the gas pipeline class.

8. The intelligent control IoT system according to claim 6, wherein the preset risk threshold is related to environmental operation condition data in a preset historical time period.

9. The intelligent control IoT system according to claim 2, wherein the smart gas company management platform is further configured to:
for the automatic control block valve:
determine an update period of an opening/closing condition of the automatic control block valve based on block valve data of the automatic control block valve and a usage duration of the gas pipeline where the automatic control block valve is located; and
periodically update the opening/closing condition of the automatic control block valve based on the update period, so that the automatic control block valve sets an updated opening/closing parameter based on an updated opening/closing condition and performs automatic control on an opening/closing state based on the updated opening/closing parameter.

10. The intelligent control IoT system according to claim 9, wherein the smart gas company management platform is further configured to:
in response to satisfying a preset period condition, adjust the update period; wherein the preset period condition includes that the opening/closing parameter of the automatic control block valve is updated in N consecutive update periods, or the opening/closing parameter of the automatic control block valve is not updated in M consecutive update periods.

11. The intelligent control IoT system according to claim 9, wherein the smart gas company management platform is further configured to:
at the beginning of each update period, acquire environmental operation condition data in a preset historical time period;
determine the opening/closing condition of the automatic control block valve in a next period based on the block valve data of the automatic control block valve, the environmental operation condition data, and future gas data in the next period; and
generate a parameter update command based on the opening/closing condition to control the automatic control block valve to update the opening/closing parameter.

12. The intelligent control IoT system according to claim 11, wherein the smart gas company management platform is further configured to:
determine the opening/closing condition of the automatic control block valve in the next period based on the block valve data of the automatic control block valve, the environmental operation condition data, and the future gas data in the next period through a threshold prediction model; wherein the threshold prediction model is a machine learning model.

13. An intelligent control IoT method for a pipeline block valve of smart gas, implemented by a smart gas company management platform of an intelligent control IoT system for a pipeline block valve of smart gas, comprising:
determining an estimated opening/closing duration of a block valve based on block valve data of the block valve and historical gas data of a gas pipeline where the block valve is located;
determining a control mode of the block valve based on the estimated opening/closing duration and gas pipeline data of the gas pipeline where the block valve is located, wherein the control mode includes automatic control and remote control;
determining a remote control block valve group and an automatic control block valve group based on the control mode of the block valve;
adjusting a recipient set of a remote control command based on the remote control block valve group, so that the remote control command is only sent to a remote control block valve; and
generating an automatic opening command based on the automatic control block valve group and sending the automatic opening command to an automatic control block valve, so that the automatic control block valve performs automatic control on an opening or closing operation of the automatic control block valve.

14. The intelligent control IoT method according to claim 13, further comprising: in response to gas data of the gas pipeline where the remote control block valve is located not satisfying a first preset condition, controlling the remote control block valve to close, to block gas transmission at a node of the remote control block valve;
in response to the gas data of a gas pipeline where the remote control block valve is located satisfying a second preset condition, controlling the remote control block valve to open, to resume the gas transmission at the node of the remote control block valve; wherein the first preset condition and the second preset condition are related to different gas data thresholds; and
determining an initial opening/closing condition of the automatic control block valve based on historical incident data of a gas pipeline where the automatic control block valve is located, and sending the initial opening/closing condition to the automatic control block valve, so that the automatic control block valve sets an initial opening/closing parameter based on the initial opening/closing condition and automatically performs an opening and/or closing operation based on the initial opening/closing parameter; wherein the opening/closing parameter includes a gas data threshold when the automatic control block valve needs to perform the opening/closing operation.

15. The intelligent control IoT method according to claim 13, wherein the determining an estimated opening/closing duration of a block valve based on block valve data of the block valve and historical gas data of a gas pipeline where the block valve is located includes:
determining the estimated opening/closing duration of the block valve based on the block valve data of the block valve and the historical gas data of the gas pipeline where the block valve is located through a duration prediction model; wherein the duration prediction model is a machine learning model.

16. The intelligent control IoT method according to claim 13, wherein the determining a control mode of the block valve based on the estimated opening/closing duration and the gas pipeline data of the gas pipeline where the block valve is located includes:
determining the control mode of the block valve based on the estimated opening/closing duration, the gas pipeline data of the gas pipeline where the block valve is located, and an opening/closing state of the block valve.

17. The intelligent control IoT method according to claim 14, wherein the first preset condition further includes that an estimated risk value of the gas pipeline where the remote control block valve is located in a preset future time period is not greater than a preset risk threshold;
the determining the estimated risk value includes:
constructing a risk map based on the gas data and gas pipeline data of the gas pipeline where the remote control block valve is located; and
determining the estimated risk value of the gas pipeline where the remote control block valve is located in the preset future time period through a risk prediction model based on the risk map, wherein the risk prediction model is a machine learning model.

18. The intelligent control IoT method of claim 17, wherein a training data set for training the risk prediction model includes a plurality of training subsets, one of the plurality of training subsets corresponds to at least one gas pipeline class, a quantity of training subsets corresponding to each gas pipeline class is greater than a subset quantity threshold corresponding to the gas pipeline class; and the subset quantity threshold corresponding to each gas pipeline class is determined based on a count of opening/closing operations of sample block valves corresponding to sample gas pipelines contained in the training subsets corresponding to the gas pipeline class.

19. The intelligent control IoT method of claim 14, further comprising:
for the automatic control block valve:
determining an update period of an opening/closing condition of the automatic control block valve based on block valve data of the automatic control block valve and a usage duration of the gas pipeline where the automatic control block valve is located; and
periodically update the opening/closing condition of the automatic control block valve based on the update period, so that the automatic control block valve sets an updated opening/closing parameter based on an updated opening/closing condition and performs automatic control on an opening/closing state based on the updated opening/closing parameter.

20. The intelligent control IoT method of claim 19, further comprising:
at the beginning of each update period, acquiring environmental operation condition data in a preset historical time period;
determining the opening/closing condition of the automatic control block valve in a next period based on the block valve data of the automatic control block valve, the environmental operation condition data, and future gas data in the next period; and
generating a parameter update command based on the opening/closing condition, to control the automatic control block valve to update the opening/closing parameter.
